(19) United States
(12) Patent Application Publication
(10) Pub. No.: US 2022/0305795 A1
(43) Pub. Date: Sep. 29, 2022

(54) CHIMNEY DEVICES

(71) Applicant: Hewlett-Packard Development Company, L.P., Spring, TX (US)

(72) Inventors: Michael Joseph Han, Vancouver, WA (US); Jafar N. Jefferson, Vancouver, WA (US); Saurabh Shripad Bhide, Vancouver, WA (US); Jeremy Barker, Vancouver, WA (US); Keith Jariabka, Vancouver, WA (US)

(21) Appl. No.: 17/209,547

(22) Filed: Mar. 23, 2021

(51) Int. Cl. B41J 2/175

(52) U.S. Cl. CPC B41J 2/17506

(57) ABSTRACT

In some examples, the disclosure describes a device that includes a moveable carriage, a chimney coupled to a first side of the moveable carriage to be positioned to receive a print substance when the moveable carriage is in a particular position, and a reservoir coupled to a second side of the moveable carriage to collect the print substance received at the chimney.

### BACKGROUND

A printing device can deposit a printing substance on to a print media to generate images on the print media. The printing substance can be deposited by dispensers (e.g., inkjet pens, etc.) that can experience malfunctions when the printing substance dries, which can block the flow of the printing substance. In some examples, the dispenser can deposit (e.g., spit) excess print substance (e.g., ink, etc.) through the dispensers to unblock or reapply moisture to fix the malfunction.

### BRIEF DESCRIPTION OF THE DRAWINGS

FIG. 1 illustrates an example of a chimney for a maintenance carriage to receive print substance.

FIG. 2 illustrates an example of a chimney for a maintenance carriage to receive print substance.

FIG. 3 illustrates an example of a maintenance carriage that includes a chimney to receive print substance.

FIG. 4 illustrates an example of a maintenance carriage that includes a chimney to receive print substance.

FIG. 5 illustrates an example of a maintenance carriage that includes a chimney to receive print substance.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, networking device (e.g., router, switch, etc.), and/or a mobile device (e.g., a smart phone, tablet, personal digital assistant, smart glasses, a wrist-worn device, etc.), among other types of computing devices. As used herein, a mobile device refers to devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

Computing devices can be utilized in combination with printing devices to send image data to the printing devices. In this way, digital data from a computing device can be utilized to generate physical representations of the digital data on a substrate. As used herein, a printing device includes a device that can deposit a printing substance on to a substrate or print media to generate an image on the substrate. As used herein, a substrate can include a material that can receive a printing substance to generate a permanent or semi-permanent image on the material. In some examples, the printing device can include an inkjet printing device that can deposit an ink substance on a substrate to generate an image on the substrate.

In some examples, the printing device can deposit the printing substance through a plurality of dispense nozzles and/or a dispenser that includes a plurality of dispense nozzles. As used herein, a dispense nozzle can include a device or system that is used to dispense or propel droplets of a print substance on to a surface of a substrate or print medium. In some examples, the print substance can dry within the dispenser or a system of the dispenser. In these examples, the dispenser can provide print substance through the system prior to initiating a print process to ensure that the dried print substance or excess print substance is removed from the dispenser. In some examples, the process of dispensing a print substance to prime or prepare a dispenser for a print process can be referred to as a spit process. In some examples, the spit process can generate droplets of print substance and/or aerosols of print substance. As used herein, the droplets can be relatively larger than the aerosols. For example, droplets can be 1 millimeter to 2 millimeters in diameter while an aerosol can be 1 micron to 100 microns in diameter.

During a spit process, the print substance can be dispensed from the dispenser in the form of droplets and/or aerosols. In order to capture the print substance during a spit process, a chimney can be positioned between the dispenser and a collection area to direct the print substance toward the collection area. As used herein, a chimney can include a vertical structure with an interior cavity that allows a substance to pass from a first end to a second end. For example, a chimney can be a structure that extends in a vertical direction to allow a print substance to be transferred in a vertical direction within the cavity of the chimney. In some examples, a chimney may be a moveable device that is attached to a maintenance carriage such that the chimney can be moved to a plurality of different locations. As used herein, a maintenance carriage can include a carriage device that moves components for maintenance operations from a first location to a second location. During a spit process, the chimney can be moved to a location directly below the dispenser to direct the print substance to the collection area. However, in some examples, the chimney can be aligned with a platform barrier surrounding the collection area that directs the print substance from the chimney to the collection area.

In this way, a space can exist between the chimney and the platform barrier even when the chimney is directed in a designated location below the dispenser. In these examples, the space between the chimney and the platform barrier can allow aerosols to escape to locations within or outside the printing device other than the collection area. These aerosols can cause damage to the printing device, a print job, and/or provide print substance accumulation at locations that can be detrimental to the use of the printing device.

The present disclosure relates to a maintenance carriage that includes a chimney protruding from a first side and a reservoir or enclosure on a second side to receive printing substance from the chimney. In these examples, the chimney and reservoir can be sealed and move with the maintenance carriage. In this way, aerosols are not able to disperse through spaces between the chimney and the reservoir since the chimney, a portion of the maintenance carriage, and/or the reservoir can be a solid or continuous material with no spaces between the coupling or connections. In some examples, the reservoir can include a plurality of apertures or holes directed toward a collection area of a platform. In these examples, the plurality of apertures can be covered by an absorbent material to prevent aerosols from escaping the reservoir while allowing droplets to deposit on to the collection area of the platform. In this way, the present disclosure can prevent aerosols from escaping the area of the maintenance carriage and/or being deposited in locations other than the designated collection area.

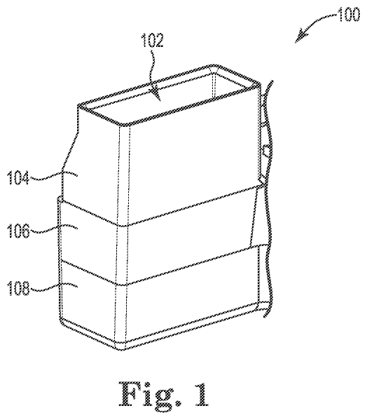

FIG. 1 illustrates an example of a chimney 100 for a maintenance carriage to receive print substance. In some examples, the chimney 100 can be part of a maintenance carriage that includes an aperture 102 to receive a print substance from a dispenser, nozzle, pen, and/or print substance dispenser system of a printing device. As described herein, a print substance dispenser can include a device or system that can be utilized to deposit a print substance on to a substrate to generate images on the substrate. As described herein, the print substance dispenser can become clogged when the print substance is allowed to stay within the print substance dispenser for a period of time, which can cause a drying of the print substance.

In some examples, the printing device can utilize a spit process to clear the print substance dispenser of the clogged or dried print substance. In this way, the print substance dispenser can deposit a quantity of print substance in an area that is not designated for a substrate and/or not designated to generate an image on a substrate. In this way, the print substance dispenser can increase an image quality of images generated on the substrate by removing the clogged or dried print substance prior to initiating a printing process. As described herein, the spit process can generate droplets and/or aerosols to be deposited from the print substance dispenser.

The chimney 100 can be coupled to a maintenance carriage that can be utilized for performing wiping operations, capping operations, or other maintenance operations. In some examples, the maintenance carriage can include a plurality of components that are coupled to a first side (e.g., top side, component side, etc.) for performing maintenance operations. As used herein, maintenance operations can refer to operations of the printing device that are performed prior to or subsequent to a printing process. For example, the maintenance operations can prepare print substance dispensers for performing a printing process and/or prepare print substance dispensers for ending a printing process. In some examples, the maintenance operations can include wiping operations, capping operations, spit operations, and/or other operations that can be performed on components of the printing device.

In some examples, the maintenance carriage can be coupled to a platform of a printing device. As used herein, a platform of a printing device or printing device platform refers to a structural support, baffle, or area within an enclosure of the printing device. In some examples, the platform can be utilized to support brackets, drive motors, drive trains, gears, and/or other mechanical components that are associated with moving the maintenance carriage. In some examples, a portion of the platform can be a support structure that can be utilized as a collection area for printing substance deposited during a spit process. In some examples, the maintenance carriage can be positioned on the platform and move along a surface of the platform. For example, the surface of the platform and a surface of the maintenance carriage can be parallel or substantially parallel such that the maintenance carriage can move along a surface of the platform. In these examples, a drive train that includes a drive motor, gears, and/or drive belt can be utilized to move the maintenance carriage.

In some examples, the chimney 100 can include a chimney portion 104, a carriage portion 106, and/or a reservoir portion 108. In some examples, the chimney portion 104, the carriage portion 106, and/or the reservoir portion 108 can be sealed together between the portions. For example, the chimney portion 104 can be sealed to the carriage portion 106 and the carriage portion 106 can be sealed to the reservoir portion 108. As used herein, a first portion can be sealed to a second portion when the first portion is permanently or substantially permanently connected without spaces or gaps between the portions that can allow particles, such as aerosols to pass through. As described herein, the gaps or spaces between portions of a chimney can allow print substance aerosols to escape and be deposited in locations other than the collection area or intended area. Thus, in some examples, the chimney portion 104, carriage portion 106, and/or reservoir portion 108 can be sealed together in order to prevent aerosols from escaping between the chimney portion, 104, carriage portion 106, and/or reservoir portion 108.

In some examples, the chimney portion 104 can include an aperture 102 that can be positioned to receive print substance that is deposited by a print substance dispenser during a spit process. For example, the maintenance carriage of the printing device can move the chimney portion 104 to a location to receive the print substance deposited by the print substance dispenser. The shape and/or size of the aperture 102 can be based on a shape and/or size of the print substance dispenser such that the aperture 102 is capable of receiving print substance that his deposited from the print substance dispenser. In some examples, the aperture 102 can be positioned proximately below the print substance dispenser such that print substance aerosols and/or droplets are not able to escape between the aperture 102 of the chimney portion 104 and the print substance dispenser. In this way, the chimney portion 104 can receive the print substance from the print substance dispenser during a spit process.

In some examples, the chimney portion 104 can direct the received print substance through the aperture 102 to the carriage portion 106. The carriage portion can be coupled to the maintenance carriage as described further herein. In some examples, the carriage portion 106 can direct the received print substance from the chimney portion 104 to the reservoir portion 108. In some examples, the carriage portion 106 can be a channel to allow the print substance to be transported from the chimney portion 104 to the reservoir portion 108 through the force of gravity. In other examples, print substance could be transported to the reservoir portion 108 through capillary wicking. For example, a medium and/or capillary channels manufactured in the chimney 100 and/or maintenance carriage could transport the print substance through the chimney 100. As used herein, capillary wicking (e.g., capillary action, etc.) can refer to an ability of a liquid (e.g., print substance, etc.) to move in a particular direction through a narrow channel without an assistance of an external force (e.g., pump, gravity, etc.). As described herein, the carriage portion 106 can be sealed to the chimney portion 104 such that the chimney portion 104 is projected in a first direction away from the carriage portion 106 and sealed to the reservoir portion 108 such that the reservoir portion 108 is projected in a second direction away from the carriage portion 106.

In some examples, the carriage portion 106 can be coupled to the reservoir portion 108. As described herein, the connection between the carriage portion 106 and the reservoir portion 108 can be a sealed connection that can prevent aerosols and/or droplets of print substance from escaping through the connection. In some examples, the reservoir portion 108 can be moveable with the carriage portion 106 and/or the chimney portion 104. For example, the maintenance carriage can be utilized to move the chimney 100 as a single piece when the maintenance carriage moves from a first location to a second location. In this way, aerosols may be prevented from escaping the chimney 100 when the maintenance carriage moves from the first location to the second location.

As described further herein, the reservoir portion 108 can include a plurality of apertures that can be positioned on a bottom surface of the reservoir portion 108 as illustrated in FIG. 1. For example, the bottom surface of the reservoir portion 108 can be parallel and/or proximate to a platform of the printing device. In this example, the plurality of apertures can allow droplets to be deposited on to the platform of the printing device. In some examples, the plurality of apertures can be covered by an absorbent material that can prevent aerosols from escaping through the plurality of apertures. In this way, the aerosols can be absorbed through the absorbent material and deposited as droplets when the accumulation of aerosols and/or droplets of print substance exceeds a threshold absorbent level for the absorbent material.

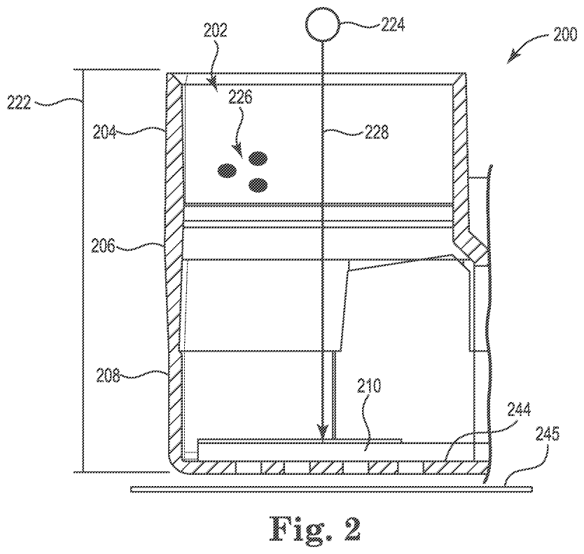

FIG. 2 illustrates an example of a chimney 200 for a maintenance carriage to receive print substance. The chimney 200 can illustrate a cut away view of the chimney 100 as illustrated in FIG. 1. In this way, the chimney 200 can illustrate the internal structure of the chimney 100 as illustrated in FIG. 1. For example, the chimney 200 can illustrate the internal structure of the chimney portion 204, carriage portion 206, and reservoir portion 208 of the chimney 200.

As described herein, the chimney 200 can include an aperture 202 that can be positioned proximate to a print substance dispenser during a spit process. As described herein, the print substance dispenser can deposit different sizes of print substance. For example, the print substance dispenser can deposit print substance droplets 224, print substance aerosols 226, and/or other sizes of print substance particles during the spit process. As described herein, a print substance droplet 224 can be relatively larger in diameter than a print substance aerosol 226. In some examples, the print substance aerosols 226 can more easily move around the inside of the chimney 200 since the mass of the print substance aerosols 226 can be relatively smaller than the print substance droplets 224. In this way, the print substance droplets 224 may drop through the chimney 200 as indicated by arrow 228 relatively faster than the print substance aerosols 226. In order to prevent the print substance aerosols 226 from escaping between spaces or gaps between the chimney portion 204, carriage portion 206, and/or reservoir portion 208, the chimney 200 can include a continuous wall 222 that extends from the aperture 202 to a base of the reservoir portion 208. Previous chimneys could utilize separate pieces to allow the chimney portion 204, carriage portion 206, and/or reservoir portion 208 to be separated and be allowed to move independently from the other portions. However, these previous chimneys would include spaces or gaps that can allow the print substance aerosols 226 to escape from the interior of the previous chimneys, which can cause damage to the printing device and/or print jobs generated by the printing device.

In some examples, the chimney portion 204 and the carriage portion 206 can be utilized to capture and/or direct the print substance droplets 224 and/or print substance aerosols 226 to the reservoir portion 208. In some examples, the reservoir portion 208 can include a plurality of apertures 244 positioned on a base side of the reservoir portion 208. In some examples, the plurality of apertures 244 can allow print substance to be deposited from the reservoir portion 208 of the chimney 200. In some examples, the print substance can be deposited through the plurality of apertures 244 with a force of gravity.

In some examples, the reservoir portion 208 can include an absorbent material 210 that can be positioned to cover the plurality of apertures 244. For example, the plurality of apertures 244 can be positioned through a base plate of the reservoir portion 208. In this example, the absorbent material 210 can be positioned on the interior of the base plate to cover the plurality of apertures 244. In this way, the print substance droplets 224 and/or print substance aerosols 226 can be absorbed by the absorbent material 210 and then deposited through the plurality of apertures 244 to a collection area 245. As described herein, the collection area 245 can be a portion of a printing device platform that can be utilized to deposit waste or excess print substance.

As used herein, an absorbent material 210 can include a material that is capable of absorbing a print substance. For example, the absorbent material 210 can be a material that is capable of absorbing or collecting a liquid when the print substance is a liquid ink. In some example, the absorbent material 210 can be a felt material, sponge like material, web material, or other type of substrate material that can accumulate a quantity of print substance. When the absorbent material 210 exceeds a threshold quantity of substance that is absorbed into the absorbent material 210, a portion of the substance can be removed from the absorbent material 210 through the plurality of apertures 244 and deposited on to the collection area 245. In some examples, the absorbent material 210 can be utilized to prevent the print substance aerosols 226 from escaping through the plurality of apertures 244 as aerosols. In this way, the print substance aerosols 226 may still be able to travel to other locations within the printing device or outside the printing device. Thus, in these examples, the print substance aerosols 226 can be absorbed by the absorbent material 210 and deposited as relatively larger quantities through the plurality of apertures 244.

In other examples, the absorbent material 210 can also prevent the print substance droplets 224 from dropping directly from the print substance dispenser to the collection area 245 in the direction of arrow 228. For example, the distance between the print substance dispenser and the collection area 245 can cause the print substance droplets 224 to create splatter on the collection area 245, which can cause print substance to travel to other locations within the printing device or outside the printing device. In this way, the absorbent material 210 can absorb the print substance droplets 224 and more uniformly deposit print substance on to the collection area 245.

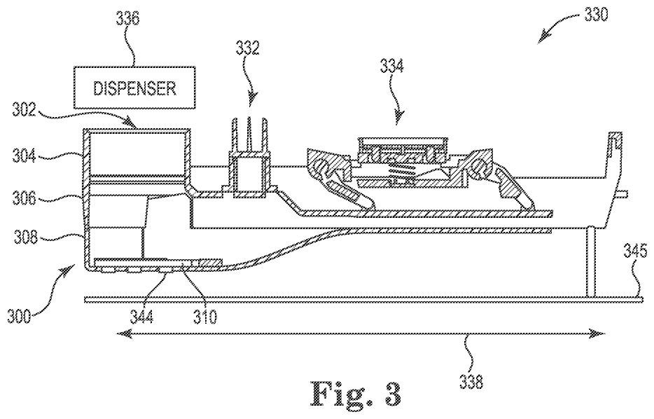

FIG. 3 illustrates an example of a maintenance carriage 330 that includes a chimney 300 to receive print substance. As described herein, a maintenance carriage 330 can be a device that include maintenance components (e.g., wiper blades 332, pen cap 334, etc.) that can be utilized for maintaining a print substance dispenser 336. In some examples, the maintenance carriage 330 can be positioned between the print substance dispenser 336 and a platform 345. In these examples, the maintenance carriage 330 can be coupled to a mechanical system and/or the platform 345 to allow the maintenance carriage 330 to move along a surface of the platform 345 in the directions of arrow 338.

That is, the maintenance carriage 330 can move to align the print substance dispenser with the aperture 302 of the chimney 300 as illustrated in FIG. 3. In addition, the maintenance carriage 330 can also be moved to align the wiper blades 332 positioned on the first side of the maintenance carriage 330 with the print substance dispenser 336 and/or moved to align the pen cap 334 positioned on the first side of the maintenance carriage 330 with the print substance dispenser 336. In these examples, the maintenance carriage 330 can move to the different locations relative to the platform 345 based on which components of the maintenance carriage 330 are to interact with the print substance dispenser 336.

As described herein, the chimney 300 of the maintenance carriage 330 can be directly coupled with the maintenance carriage 330 such that the chimney portion 304, carriage portion 306, and reservoir portion 308 move with the maintenance carriage 330 in the direction of arrow 338. In this way, the chimney portion 304, carriage portion 306, and reservoir portion 308 can create a sealed area to direct print substance droplets and/or print substance aerosols from the print substance dispenser 336 to the absorbent material 310 and through the plurality of apertures 344 to the collection area on the platform 345. In this way, the relatively smaller print substance aerosols are not able to escape through gaps or spaces between the chimney portion 304, carriage portion 306, and/or carriage portion 306 since the chimney portion 304, carriage portion 306, and carriage portion 306 create a sealed enclosure and move with the maintenance carriage 330 instead of moving independently.

In some examples, the carriage portion 306 includes an absorbent material 310 that can be positioned on the apertures 344 that protrude through a base surface or bottom surface of the carriage portion 306. In this way, the print substance aerosols, print substance droplets, and/or print substance particles are forced to accumulate within the absorbent material 310 prior to be being deposited through the apertures 344 and on to the platform 345.

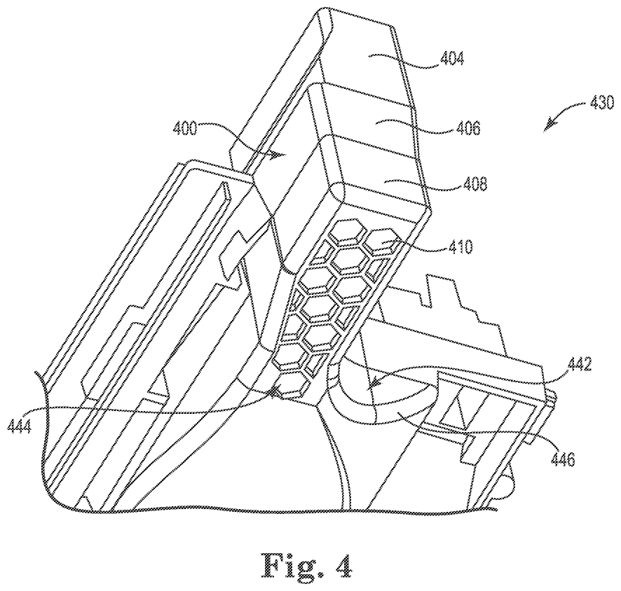

FIG. 4 illustrates an example of a maintenance carriage 430 that includes a chimney 400 to receive print substance. In some examples, the maintenance carriage 430 can be a bottom view of the maintenance carriage 330 as illustrated in FIG. 3. For example, the maintenance carriage 430 can illustrate a surface that is directed toward a platform (e.g., platform 345 as illustrated in FIG. 3, etc.). As described herein, the chimney 400 can include a chimney portion 404, a carriage portion 406, and/or a reservoir portion 408. As described herein, the chimney portion 404, carriage portion 406, and/or reservoir portion 408 can be directly coupled together to form a sealed chamber to prevent print substance aerosols from escaping through spaces between the portions.

In some examples, the maintenance carriage 430 can include a skid pad 446 that is positioned along edges of a bottom surface of the maintenance carriage 430. As used herein, a skid pad 446 can include a surface to interact with a substance deposited on a platform. For example, the skid pad 446 can include a material attached to the surface of the maintenance carriage 430 to interact with a quantity of print substance that has accumulated on a surface of the platform. In some examples, the skid pad 446 can be a flexible material that can extend from the bottom surface of the maintenance carriage 430 toward the platform. In this way, the skid pad 446 can move over the surface of the platform and/or make contact with the platform without creating resistance that can be created with a less flexible material.

As described herein, the reservoir portion 408 can include a plurality of apertures 444 positioned on a bottom surface of the reservoir portion 408 In some examples, the plurality of apertures 444 can be covered by an absorbent material 410 that can be positioned along an interior surface of the reservoir portion 408 to prevent print substance aerosols from escaping through the apertures 444 as described herein. In some examples, the print substance aerosols are forced to be absorbed through the absorbent material 410 prior to being deposited through the plurality of apertures 444.

In some examples, the maintenance carriage 430 can include a plow device 442 positioned proximate to the chimney 400. In some examples, the plow device 442 and/or the chimney 400 can be positioned along the same edge of the maintenance carriage 430. In some examples, the plow device 442 can extend from the bottom portion of the maintenance carriage 430 to interact with a print substance that is deposited proximate to the chimney 400. In some examples, a print zone can include a first print dispenser to dispense a first type of print substance and a second print dispenser to dispense a second type of print substance. In these examples, a first type of print substance can be deposited within the chimney 400 and a second type of print substance can be deposited proximate to the chimney 400 such that the second type of print substance is deposited at a location that can interact with the plow device 442.

In some examples, the first type of print substance can have a first composition that is different than a second composition of the second type of print substance. For example, the first type of print substance can include a color ink (e.g., cyan, magenta, yellow, red, etc.) and the second type of print substance can include a black ink. In this example, the color ink can be separated from the black ink by depositing the color ink into the chimney 400 and depositing the black in at a proximate location to the chimney 400.

As used herein, a plow device 442 can include a device structure to move or interact with an accumulation of a substance deposited on a surface. For example, the plow device 442 can include a device that is projected in a direction toward a platform from a bottom surface of the maintenance carriage 430 to interact with a print substance that is deposited at a collection area of a platform. In some examples, the plow device 442 can spread accumulated print substance such that the accumulated print substance does not exceed a particular height from the platform. For example, accumulate print substance could reach a height that can interact with the maintenance carriage 430 when the maintenance carriage 430 moves over the collection area of the platform. In this way, the plow device 442 can prevent the print substance from exceeding a threshold height from the platform by leveling the accumulated print substance deposited at the collection area of the platform.

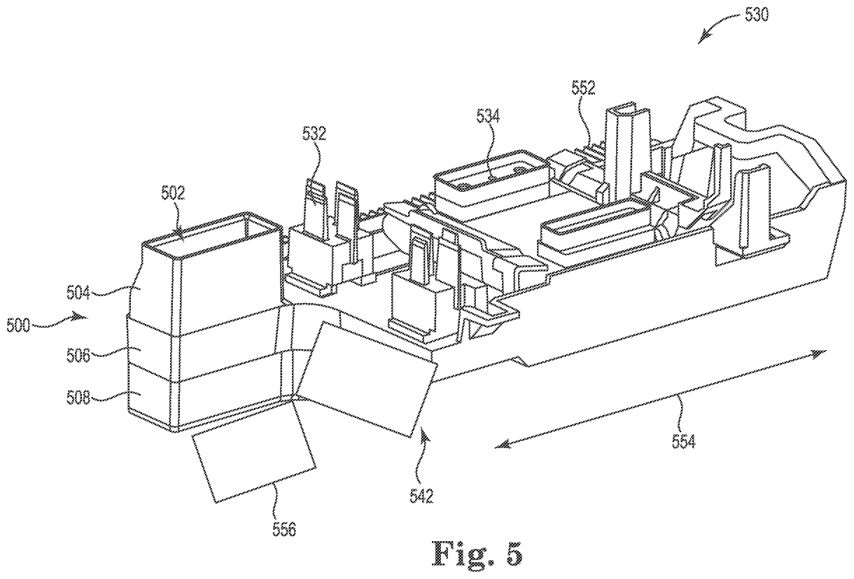

FIG. 5 illustrates an example of a maintenance carriage 530 that includes a chimney 500 to receive print substance. In some examples, the maintenance carriage 530 can include the same or similar elements as maintenance carriage 330 as illustrated in FIG. 3 and/or elements as maintenance carriage 430 as illustrated in FIG. 4. For example, the maintenance carriage 530 can include components for performing maintenance processes on a print substance dispenser. For example, the maintenance carriage 530 can include a wiper blade 532 and/or a pen cap 534. In some examples, the maintenance carriage 530 can include a drive train 552 to move the maintenance carriage 530 in the directions of arrow 554. In this way, the maintenance carriage 530 can move the chimney 500, wiper blade 532, and/or pen cap 534 to different locations based on a corresponding maintenance process. Thus, in some examples, the drive train 552 is to move the maintenance carriage 530 to the first position to align the components (e.g., wiper blade 532, pen cap 534, etc.) to wipe the print substance dispenser and move the maintenance carriage 530 to the second position to align the chimney 500 with the print substance dispenser to receive the print substance.

In some examples, the maintenance carriage 530 can include a component side that includes wiper blades 532 and a chimney 500 that extends toward a print zone to collect the first type of print substance from the first print dispenser. In some examples, the maintenance carriage 530 can include a reservoir side that includes a reservoir portion 508 (e.g., enclosure) to collect the first type of print substance from the first print dispenser through the chimney 500 and a skid plate and/or plow device 542 to interact with the second type of print substance deposited on the platform (e.g., collection area 556) by the second print dispenser. Thus, a second print substance dispenser can dispense a different print substance on a platform proximate to the chimney 500 that can be moved by the plow device 542.

In some examples, the chimney 500 can be positioned on an edge of the maintenance carriage 530 at a first location. In some examples, the chimney 500 can be positioned on the edge of the maintenance carriage 530 to allow print substance from a print substance dispenser to be deposited within an aperture 502 during a spit process. In some examples, the 500 can be positioned on a first portion of the edge of the maintenance carriage 530 to receive print substance from a first print substance dispenser and a second portion of the edge can be a void to allow a second print substance from a second print substance dispenser to deposit the second print substance directly on a collection area 556 of a platform. In some examples, the collection area 556 can be separated from a different collection area associated with the chimney 500. In this way, the collection area 556 for the second print substance can be separated from the collection area (beneath reservoir portion 508) for the first print substance.

As described herein, the collection area 556 can be proximate to the chimney 500. In some examples, a plow device 542 can be coupled to the edge of the maintenance carriage 530 such that the plow device 542 can interact with deposited print substance within the collection area 556. In this way the plow device 542 can prevent the accumulation of the print substance from exceeding a particular height threshold which may interact with other portions of the maintenance carriage 530 and potentially damage the maintenance carriage 530 or other components of the printing device. For example, black ink print substance can accumulate as a black ink sludge that can get onto the nozzles, which can cause poor nozzle health and/or inhibit the ability to eject print substance droplets. In another example, the plow device 542 can prevent accumulated print substance at the collection area 556 from getting onto the print head and/or print head carriage and then redepositing it elsewhere where it could damage the printing device and/or print media. For example, the plow device 542 can level or smooth out the accumulated print substance when the maintenance carriage 530 moves toward the collection area 556.

In some examples, the chimney 500 can include an aperture 502 to receive print substance from a print substance dispenser during a spit process. In some examples, the aperture 502 can be directed toward the print dispenser and/or print nozzle of a printing device when the spit process is occurring to collect or direct print substance droplets and/or print substance aerosols into a chimney portion 504. In some examples, the chimney portion 504 can extend in a first direction from a surface of the maintenance carriage 530 or the carriage portion 506 of the chimney 500. In this way, the chimney portion 504 can extend to a position closer to the surface of the print substance dispenser to collect a greater quantity of print substance droplets and/or print substance aerosols. In some examples, the carriage portion 506 can be a portion that extends from a top surface of the maintenance carriage 530 to a bottom surface of the maintenance carriage 530. In some examples, the reservoir portion 508 can extend from the maintenance carriage 530 and/or the carriage portion 506 toward a platform and/or collection area of the platform associated with the chimney 500. As described herein, the chimney portion 504, carriage portion 506, and/or reservoir portion 508 can be sealed together to prevent print substance aerosols from escaping between the portions.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A device, comprising:
a moveable carriage;
a chimney coupled to a first side of the moveable carriage to be positioned to receive a print substance when the moveable carriage is in a particular position; and
a reservoir coupled to a second side of the moveable carriage to collect the print substance received at the chimney.

2. The device of claim 1, wherein the reservoir coupled to the second side of the moveable carriage includes a plow device move along a surface of a platform with the moveable carriage.

3. The device of claim 2, wherein the plow device interacts with a collection area of print substance of the platform.

4. The device of claim 1, wherein the moveable carriage positions the chimney below a first print substance dispenser at the particular position to receive the print substance.

5. The device of claim 4, wherein the moveable carriage allows a second print substance dispenser to dispense a different print substance on a platform proximate to the chimney.

6. The device of claim 1, wherein the reservoir includes an absorbent material coupled to a surface of the reservoir.

7. The device of claim 6, wherein the absorbent material prevents aerosol from escaping the reservoir and allows an accumulation of the print substance to be deposited.

8. A carriage device, comprising:
a drive train to move the carriage device from a first position to a second position along a surface of a printing device platform;
a first side that includes components to wipe a print substance dispenser and a chimney that protrudes from the first side to receive print substance from the print substance dispenser when the carriage device is in the second position; and
a second side that includes a reservoir to receive the print substance through the chimney and a skid plate positioned between the reservoir and the printing device platform.

9. The carriage device of claim 8, wherein the drive train is to move the carriage device to the first position to align the components to wipe the print substance dispenser and move the carriage device to the second position to align the chimney with the print substance dispenser to receive the print substance.

10. The carriage device of claim 8, wherein the skid plate is to interact with a print substance accumulation at an collection area of the printing device platform when the carriage device moves from the first position to the second position.

11. The carriage device of claim 8, wherein the chimney is connected to the reservoir through a sealed connection with the reservoir to prevent aerosol from escaping the reservoir through the sealed connection.

12. A system, comprising:
a print zone that includes a first print dispenser to dispense a first type of print substance and a second print dispenser to dispense a second type of print substance;
a platform positioned below the print zone to receive the second type of print substance from the second print dispenser; and
a carriage device, comprising:
a drive train coupled to the platform to move the carriage device from a first position to a second position along a surface of the platform;
a component side that includes wiper blades and a chimney that extends toward the print zone to collect the first type of print substance from the first print dispenser; and
a reservoir side that includes an enclosure to collect the first type of print substance from the first print dispenser through the chimney and a skid plate to interact with the second type of print substance deposited on the platform by the second print dispenser.

13. The system of claim 12, wherein the enclosure includes a plurality of apertures to allow the first type of print substance to be deposited from the enclosure.

14. The system of claim 13, wherein the plurality of apertures are covered by an absorbent material to prevent aerosol from escaping the enclosure while allowing an accumulation of the first type of print substance to be deposited from the enclosure.

15. The system of claim 12, wherein the skid plate prevents the second type of print substance from accumulating beyond a threshold height from the platform.
